(19) United States
(12) Patent Application Publication
(10) Pub. No.: US 2026/0296161 A1
(43) Pub. Date: Oct. 1, 2026

(54) METHOD OF MOUNTING A BATTERY PACK IN A VEHICLE

(71) Applicant: Silverstone Performance Technologies Limited, Towcester Northamptonshire (GB)

(72) Inventor: Claudio SANTONI, Silverstone, Towcester Northamptonshire (GB)

(21) Appl. No.: 19/478,549

(22) PCT Filed: Apr. 26, 2024
(86) PCT No.: PCT/GB2024/051108

§ 371 Date: Oct. 24, 2025

(30) Foreign Application Priority Data
Apr. 26, 2023 (GB) 2306141.9

(51) Int. Cl. B60K 1/04; B60K 6/28; B62D 27/02; B62D 65/02; H01M 50/249; H01M 50/262

(52) U.S. Cl. CPC B60K 1/04; B62D 27/026; B62D 65/02; H01M 50/249; H01M 50/262; B60K 2001/0438; B60K 6/28; B60Y 2200/91; B60Y 2200/92; B60Y 2400/112; H01M 2220/20

(57) ABSTRACT

A method of mounting a battery pack to a vehicle body of a passenger vehicle is provided. The method comprises providing a vehicle frame defining at least a floor portion of a vehicle body. A battery pack is provided and the battery pack is arranged in the floor portion of the vehicle body. The battery pack is then bonded to the frame using at least one adhesive joint located at an interface between the battery pack and the frame.

### FIELD OF THE INVENTION

The invention relates to methods of mounting a battery pack to a vehicle body of a passenger vehicle. In particular, the invention relates to methods of mounting the traction battery, used to power the electric motors, to a vehicle body of an electric or hybrid passenger vehicle.

### BACKGROUND

In electric and hybrid passenger vehicles, it is necessary to integrate a sizeable battery pack into the vehicle body. The manner of integration off the battery pack impacts the structural, safety, comfort and operational performance of the vehicle. The battery pack is normally manufactured separately from a vehicle frame and then mounted to the vehicle frame. State of the art methods for joining the battery pack to the car body are based on mechanical fasteners to provide serviceability of the battery pack. That is, battery packs are generally attached to the frame by mechanical fasteners, such as bolts, that are quick and easy to engage and disengage to mount the battery during manufacture and subsequently remove the battery, e.g. for servicing.

One of the most significant differences of an electric or hybrid passenger vehicle relative to an internal combustion engine vehicle is the need to maintain both occupant and battery safety by avoiding pack intrusion in a crash. This is generally accomplished in part by transferring crash loads around the battery pack for frontal and rear collisions. One of the greatest design challenges is to make sure that the battery pack is protected in the event of a side impact crash or collision. This is especially challenging since there is limited space in a rocker or sill for the crumple zones needed to absorb side impact crash loads without damaging the battery pack.

Mechanical fasteners for mounting the battery pack to the car body are typically oriented with a substantially vertical axis for ease of access at point of manufacturing and service. This joint direction also enables the interface between the battery pack and the car body to be located on a substantially horizontal and flat (planar) interface in order to avoid the risk of manufacturing tolerance stack creating unwanted gaps between adjoining members (in this instance the battery pack and the vehicle body). This joint direction is also compatible with a substantial vertical direction for the installation and removal of the heavy weight battery pack. However, the mechanical fasteners used to allow a vertical mounting direction are typically inefficient at transmitting or reacting to loads that are applied perpendicularly to their main axis (i.e. shear loads). Thus, in order to keep the battery pack secure in impacts, the number and sizing of fasteners has to be increased to prevent all possible failure modes including bolt shear failure, joint slip failure, and failures at the edge of the bolt holes. Of particular importance are the shear loads originated from a side crash into the passenger vehicle, in particular side pole crashes. The reinforcement of the mechanical fasteners to attempt to prevent all possible failure modes can lead to a significant increase in the weight of the vehicle body. This is particularly disadvantageous in the context of electric vehicles, where lightweighting is an important consideration, especially where reaching a target range is an essential design consideration and the solution often involves adding more batteries and consequently more weight.

It is thus desirable to provide alternative methods for mounting battery packs within vehicle bodies that overcome the noted shortcomings with mechanical fasteners.

### SUMMARY OF INVENTION

In accordance with a first aspect of the invention, there is provided a method of mounting a battery pack to a vehicle body of a passenger vehicle, the method comprising: providing a vehicle frame defining at least a floor portion of a vehicle body; providing a battery pack; arranging the battery pack in the floor portion of the vehicle body; and bonding the battery pack to the frame using at least one adhesive joint located at an interface between the battery pack and the frame.

In accordance with the present invention, the battery pack is mounted to vehicle frame and secured, at least in part, using one or more adhesive joints at the interface between the battery pack and the frame. Adhesive joints enable a substantially lighter design if used as replacement or in combination with the mechanical fasteners. This is because adhesive joints generally possess superior abilities in transferring or reacting to shear loads compared with mechanical fasteners.

It will be appreciated that the present technique is intended for use in mounting the main vehicle battery pack (sometimes referred to as the traction battery), which is used to power the electric motor(s) of the vehicle. The method may thus further comprise connecting the battery pack to one or more electric motors of the passenger vehicle.

The vehicle frame will generally correspond to the so-called body in white (BIW), in which the frame defines at least the cabin of the passenger vehicle. However, the frame could also be a component that will later be assembled into the vehicle body or BIW. For example, the frame may comprise a floor frame, which may define the rocker and/or door sill portions of the vehicle body, which generally define the plane of the floor of the vehicle. The battery pack may thus be mounted within this floor frame before the floor frame is joined up with one or more other frame portions defining the vehicle body or BIW.

The present method may be suitable for mounting any type of battery pack to a vehicle body. This includes batteries based on different battery chemistries as well as different battery cell and module architectures. Generally, the battery pack will comprise one or more battery modules located within a housing, wherein the battery pack is mounted to the vehicle body by bonding the battery pack housing to the frame.

Preferably the battery back comprises a housing formed of a fibre-reinforced composite material, preferably comprising a resin matrix, reinforcement fibres and metallic inserts. Other battery pack housings could be used, however, such as metal housings made of aluminium alloys. The vehicle frame may be made of metal, for example an assembly of aluminium alloys. Alternatively, the frame could be formed of a fibre-reinforced composite material, which again may comprise a resin matrix, reinforcement fibres and metallic inserts.

Preferably, the adhesive joint is formed by a paste-like adhesive that is applied to either the battery pack or the vehicle frame or both, before the battery pack and vehicle frame are coupled together. In some cases, it may be advantageous to use a liquid-like adhesive and in this case the adhesive could be injected into the gap between the battery and the vehicle frame, after they have been coupled or otherwise arranged in place. Preferably, when rigidified the adhesive is able to withstand all major external loads that the joint will be subject to during the lifecycle of the vehicle and battery pack. Therefore, the adhesive is preferably a structural adhesive capable to generate sufficiently high strength in the joint, for example greater than 5 MPa, preferably greater than 10 MPa, more preferably greater than 25 MPa. Preferably, the adhesive is tough and therefore well suited to maintaining the integrity of the joint when subjected to impact loads. For example, the structural adhesive fracture toughness could be greater than 0.1 N/mm, preferably greater than 1 N/mm, more preferably greater than 10 N/mm.

Preferably, the adhesive exhibits thixotropic behavior to facilitate application to either the battery or the vehicle frame, by hand or by an automated delivery system.

Preferably, the adhesive viscosity is moderate in order to limit the load required to couple the battery pack to the vehicle frame due to the hydraulic lock originating from adhesive flow.

The adhesive is preferably applied to the battery pack when this is de-coupled from the vehicle frame and the adhesive application surface is predominantly horizontal and facing upwards. The adhesive is preferably capable of filling gaps and therefore compensating any small geometrical variations between vehicle frame and battery pack due to manufacturing and assembly tolerances.

The adhesive chemistry is preferably selected from widely available commercial grades for structural adhesives, preferably polyurethane or epoxy or acrylic or others.

The adhesive is preferably of a different colour relative to the colour of the vehicle frame and the battery pack, for example a bright color, to provide visual confirmation of its presence for inspection purposes.

Preferably, the adhesive exhibits resistance to fire in line with international requirements (example ECER100) for battery systems in passenger vehicles.

In some embodiments, the adhesive may be electrically conductive. For example, the adhesive may comprise electrically conductive additives, such as graphene. An electrically conductive adhesive may be useful to electrically connect the battery pack to the frame for a ground circuit.

Typically, the adhesive used to form the adhesive joint will be pre-coated onto the battery pack or the frame before the battery pack is arranged in the floor portion of the vehicle. In particular, the adhesive may be coated onto the parts of the frame or battery pack that will subsequently form part of the interface. Once the battery pack is arranged in place, the frame and the battery pack may be pressed together while the adhesive bonds the two together.

Another advantage of an adhesive joint is that it may improve manufacturing tolerance owing to the ability of the adhesive to fill gaps in the surfaces being bonded. The thickness of the adhesive layer may need to be adjusted to appropriately accommodate such surface variations due to manufacturing tolerances. It has been found that the thickness of each adhesive joint should be at least 0.5 mm, preferably at least 1 mm, more preferably at least 2 mm, most preferably at least 3 mm. A thicker adhesive joint will also allow the battery pack to be more easily removed during servicing, as will be described below. The adhesive may thus be coated onto the battery pack or frame with a thickness of at least 0.5 mm, preferably at least 1 mm, more preferably at least 2 mm, most preferably at least 3 mm. The adhesive will typically be pressed during the bonding process, and so the coating thickness of the adhesive may need to be thicker than the desired final adhesive joint thickness. The coating thickness needed to achieve a particular joint thickness will depend on the specific adhesive used, the parameters of its application and the pressure applied during the bonding process, among other factors.

While the adhesive may be provided anywhere that the battery pack interfaces with the frame, preferably, the one or more adhesive joints are located along a peripheral edge portion of the battery pack. The peripheral edge portion may be considered to be a region of the battery pack that is closer to an edge of the battery pack in the direction of a plane generally defined by the floor portion than to the central axis of the battery pack along the direction perpendicular to this plane. Generally, the frame defining the floor portion of the vehicle body will have a substantially rectangular footprint, defining opposing longitudinal edges to the floor, corresponding to the opposing sides of the vehicle body, and possibly a front edge and a rear edge corresponding to the front and rear of the vehicle respectively. The plane generally defined by the floor portion may correspond to a plane between these opposing longitudinal edges, and the front and rear edges of the frame if provided. Typically, the battery pack will also generally define a plane, having a height less than its length and width, and sit substantially aligned with the plane of the floor portion, and may also have a substantially rectangular footprint. The battery pack will typically extend across the floor portion between the opposing longitudinal edges defined by the frame. The battery pack may have opposing longitudinal edges that extend alongside the opposing longitudinal edges of the floor portion defined by the frame. Providing the adhesive joint along a peripheral edge portion of the battery pack is preferred as this is generally where the battery will interface with the frame defining the floor, and also this is generally more accessible during manufacture and servicing. The adhesive joint will typically be elongate, defining a path extending along the peripheral edge portion.

While the adhesive joint could be located along on any one or more peripheral edge portions of the battery pack, preferably the one or more adhesive joints are located along at least two opposing peripheral edge portions of the battery pack. This improves the strength of the bonding of the battery pack. For example, an adhesive joint could be provided along peripheral edge portions adjacent to the opposing longitudinal edges of the floor portion defined by the frame. In particularly preferred embodiments, the one or more adhesive joints substantially surround a centre region of the battery pack. For example, the one or more adhesive joints may extend along opposing longitudinal edge portions of the battery pack and along front and rear edge portions of the battery pack. In this case, there may be one long continuous adhesive joint extending along all four edge portions, or a number of separate adhesive joints along these edge portions. Providing the adhesive along a greater proportion of the edge of the battery pack improves the strength of the bonding with the frame.

There are various possible ways the interface between the battery pack and the frame may be designed. In a simple case, the battery pack may have a flat upper or lower surface and may sit against a flat floor surface provided by the frame. However, the interface may be designed to provide further advantages to the mounting method. In particular, in some embodiments, the battery pack comprises one or more peripheral flanges configured to form at least part of the interface with the frame, and the one or more adhesive joints are located along one or more of said peripheral flanges. It will be appreciated that other adhesive joints could also be provided in regions away from the peripheral flange. The frame may also be provided with one or more complementary rim portions configured to engage the peripheral flange portions of the battery pack. Providing a peripheral flange of the battery pack, on which the adhesive joint is to be provided, may be provide numerous advantages, including ensuring the adhesive joint is spaced from the battery cells of the battery pack, which is advantageous during servicing. Furthermore, the use of a peripheral flange with complementary rim may help seat the battery pack in the frame.

Another advantageous way in which the interface may be configured is for the interface between the battery pack and the frame to include one or more portions that define a substantially stepped interface. Preferably the at least one adhesive joint is located on at least two different surfaces of one or more of said portions defining the substantially stepped interface. Again, this could be provided by one adhesive joint that extends across both surfaces, or separate adhesive joints. A stepped interface may define surface portions at two different height levels (in a direction perpendicular to a plane generally defined by the floor) along which adhesive joints may be arranged. Alternatively, a stepped interface may allow adhesive joints to be provided along surfaces that are at different angles to one another, e.g. substantially perpendicular to one another, so that the joints experience impact forces in different relative directions. Furthermore, a stepped interface may again aid with seating the battery pack in the frame prior to bonding with the adhesive joints.

As described above, the floor portion of the vehicle generally defines a plane, and the battery pack will also generally define a plane that is substantially aligned with or at least parallel with the plane of the floor. However, it may be preferred that the interface between the battery pack and the frame includes one or more portions arranged at an angle (preferably an oblique angle) to the plane defined by the floor portion, and the at least one adhesive joint is located at said one more portions of the interface that are arranged at an angle to the plane defined by the floor portion. In particular, preferably the interface between the battery pack and the frame includes one or more portions defining an angle of less than 45° to the plane defined by the floor portion, more preferably less than 30°, most preferably less than 20° to the plane defined by the floor portion. This may, for example, involve a peripheral flange portion of the battery pack defining an oblique angle relative to the general plane of the battery pack and a portion of the frame being provided with a complementary angle to engage the peripheral flange portion. The provision of portions of the interface that are neither parallel with nor perpendicular to the plane generally defined by the floor portion of the frame can help the adhesive joint handle impact forces. In particular, impact forces that are along a direction within the plane of the floor may thus partly put the adhesive joint into compression instead of pure shear. For the most advantageous handling of impact forces, the one or more inclined portions of the interface between the battery pack and the frame should be arranged at an angle that is generally inclined towards or away from a centre of the battery pack. For example, inclined portions that lie along the longitudinal edge of the battery pack should be inclined about a longitudinal axis in the plane of the floor, whereas inclined portions that lie along the front or rear edge of the battery pack should be inclined about a transverse axis in the plane of the floor, so that the longitudinal edges advantageously handle side impact forces and the front and rear edges advantageously handle front and rear impact forces.

In some embodiments of the present method, the frame defines an opening therethrough at the floor portion, and the battery pack closes said opening, thereby defining at least a region of the floor of the vehicle. In other words, the battery pack itself acts as a substantial section of a floor surface of the vehicle body.

In other embodiments, the frame may define a substantially continuous floor surface at the floor portion of the vehicle body, and wherein the battery pack is arranged substantially adjacent to said floor surface, e.g. with the plane of the battery pack parallel to the plane of said floor surface. In such an embodiment, the floor surface of the vehicle body is provided by the frame, which may simplify removal and replacement of the battery pack during servicing.

The frame defining the floor portion may comprise, for example, longitudinal structural members such as the rocker or door sill portions of the frame, or the centre tunnel structure, with one or more transverse structural members generally corresponding to front and rear edges of the floor portion. If provided, an opening through the frame may extend substantially between the longitudinal and transverse structural members. The battery pack may thus substantially fill this opening through the frame and be bonded to the longitudinal and/or transverse structural members by the adhesive joints. Such an arrangement may make the vehicle body lighter. In other embodiments, the substantially continuous floor may extend between the longitudinal and transverse structural members and the battery pack may be bonded to the longitudinal and/or transverse structural members and/or to the floor surface of the frame by the adhesive joints.

While the present method makes use of adhesive joints to overcome a number of shortcomings with mechanical fasteners, in many embodiments, it may be preferred to use both mounting means to benefit from the advantages each provides. Therefore, in some embodiments, the method further comprises fixing the battery pack to the frame using one or more mechanical fasteners. The mechanical fasteners may be located at an interface between the battery pack and the frame. In particularly preferred embodiments, the mechanical fasteners may be used to locate and hold the battery pack in place relative to the frame for a subsequent bonding using the adhesive joints. Therefore, preferably, arranging the battery pack in the floor portion of the vehicle body comprises engaging one or more mechanical fasteners located at an interface between the battery pack and the frame to guide and/or hold said battery pack in place on said frame. Alternatively, a guiding effect may be achieved by guide members provided on the battery pack and the frame, such as dowel pins and corresponding openings. Mechanical fasteners are preferred for their contribution to holding the battery pack in place in case of adhesive failure and during setting of the adhesive. In particular, preferably bonding the battery pack to the frame comprises clamping the battery pack to the frame using one or more mechanical fasteners while the adhesive rigidifies. While it is preferred that the mechanical fasteners are used to urge the frame and the battery pack together, it may be desirable to ensure a particular spacing between the battery pack and the frame, e.g. to prevent too much adhesive being squeezed out of the joint or to ensure the battery pack is level in the frame. Therefore, preferably, the one or more mechanical fasteners include one or more spacing elements configured prevent direct contact between the battery pack and the frame, and preferably configured to ensure a predetermined minimum spacing between the battery pack and the frame.

It has been described above that the frame may comprise longitudinal and transverse structural members, with the battery pack bonded to those structural members. More generally, the frame may comprise opposing structural members, and the method comprises arranging the battery pack between the opposing structural members and joining the battery pack to each of the opposing structural members, wherein preferably joining the battery pack to one or more of the opposing structural members comprises bonding the battery pack to said structural member using an adhesive joint located at an interface between the battery pack and said structural member. In this way, the battery pack may form a load path between the opposing structural members, such that the impact forces may be transmitted between the opposing structural members by the battery pack. Preferably, the battery pack may be joined to each of two sets of opposing structural members in this way, preferably two perpendicular sets of opposing structural members, such as a pair of longitudinal structural members, e.g. door sill portions, and transverse structural members, e.g. front and rear structural members. In particularly preferred embodiments in which the interface between the battery pack and the frame includes one or more portions arranged at an angle to the plane defined by the floor portion and the at least one adhesive joint is located at said one more portions of the interface that are arranged at an angle to the plane defined by the floor portion, the opposing structural members define the one or more portions arranged at an angle to the plane defined by the floor portion, wherein preferably each opposing structural member defines a respective portion arranged at an angle to the plane defined by the floor portion, the at least one adhesive joint preferably being arranged at each of said respective portions arranged at an angle to the plane defined by the floor portion. In other embodiments, the interface with the opposing structural members may define a substantially stepped interface, with the at least one adhesive joint located on at least two different surfaces of one or more of said portions defining the substantially stepped interface.

Alternatively, or additionally, the frame may define at least part of a floor surface (e.g. partial or continuous) at the floor portion of the vehicle body and a structural member extending away from the floor surface, and the method may comprise joining the battery pack to the structural member and joining the battery pack to the floor surface of the frame, wherein preferably joining the battery pack to the structural member comprises bonding the battery pack to the structural member using an adhesive joint located at an interface between the battery pack and the structural member and/or wherein preferably joining the battery pack to the floor surface comprises bonding the battery pack to the floor surface using an adhesive joint located at an interface between the battery pack and the floor surface. In this way, the battery pack may define part of a load path for transmitting impact forces from the structural member into the floor surface of the frame.

In some embodiments, the frame may comprise opposing structural members and at least a partial floor surface at the floor portion of the vehicle body, and the method may comprise arranging the battery pack between the opposing structural members and joining the battery pack to each of the opposing structural members and joining the battery pack to the floor portion, preferably at respective locations adjacent each of the opposing structural members, wherein preferably one or more, preferably each, joining step is performed by bonding using an adhesive joint located at an interface between the respective parts. In this way, load may be transmitted between the opposing structural members and between the structural members and the floor surface, thereby more effectively shielding the battery pack contents from damage.

As has been mentioned above, the frame may comprise opposing longitudinal structural members located along opposing longitudinal edges of the floor portion of the vehicle body. These structural members are particularly useful for shielding the battery pack from impact forces, and so preferably arranging the battery pack in the floor portion of the vehicle body comprises arranging the battery pack substantially between the opposing longitudinal structural members. That is, the battery pack may be arranged substantially in the plane defined between the opposing longitudinal structural members.

In some embodiments, the steps of arranging the battery pack in the floor portion of the vehicle body and bonding the battery pack to the frame comprise arranging the battery pack in the frame such that the weight of the frame acts to press against the battery back during bonding. This method is particularly useful in combination with guide elements that ensure the proper in-plane relative positioning of the battery pack and the frame. As mentioned above, the guide elements could be provided by the mechanical fasteners, or separate elements, such as dowel pins. This technique is particularly preferred over a technique of jig-setting the system, since it allows the method to be performed with lift type equipment that is readily available and there is no need for expensive and model specific jigs.

The adhesive joint should be located at a relatively rigid part of the battery pack so that it contributes to holding the battery pack in place in the frame and so that crash loads may be transferred across the joint and then directed by the battery pack in a way that shields the contents of the battery pack from damage. Preferably, the material of the battery pack at the location of the adhesive joint has a Young's modulus of at least 1 GPa, preferably at least 2 GPa, more preferably at least 3 GPa, more preferably at least 5 GPa, more preferably at least 10 GPa, more preferably at least 20 GPa, most preferably at least 50 GPa. Preferably, the adhesive joint is located on a fibre reinforced composite surface of the battery pack. Preferably, the material of the frame at the location of the adhesive joint is also rigid, having a Young's modulus of at least 1 GPa, preferably at least 2 GPa, more preferably at least 3 GPa, more preferably at least 5 GPa, more preferably at least 10 GPa, more preferably at least 20 GPa, most preferably at least 50 GPa. The frame will typically be aluminium or an aluminium allow, which may have a Young's modulus of 70 or higher.

One way that the battery pack may shield its contents from impact forces is by transmitting crash loads across the battery pack and back into another section of the frame. Therefore, preferably the battery pack comprises a housing, wherein a material of the housing extending between the adhesive joint and either another joint between the battery pack and the frame or another section of the same adhesive joint has a Young's modulus of at least 1 GPa, preferably at least 2 GPa, more preferably at least 3 GPa, more preferably at least 5 GPa, more preferably at least 10 GPa, more preferably at least 20 GPa, most preferably at least 50 GPa. In these embodiments, by providing a rigid material between two separate joints to the frame, or two different (e.g. opposing) sections of the same joint, the rigid material of the battery pack housing may form part of the load path between the two joints. One particularly preferred embodiment is one in which the battery pack is joined to two opposing structural members of the frame and the of the housing extending between the opposing structural members has a Young's modulus of at least 1 GPa, preferably at least 2 GPa, more preferably at least 3 GPa, more preferably at least 5 GPa, more preferably at least 10 GPa, more preferably at least 20 GPa, most preferably at least 50 GPa. Preferably, the battery pack comprises a housing surrounding one or more internal battery modules, and substantially the whole of the housing has a Young's modulus of at least 1 GPa, preferably at least 2 GPa, more preferably at least 3 GPa, more preferably at least 5 GPa, more preferably at least 10 GPa, more preferably at least 20 GPa, most preferably at least 50 GPa. While preferred, in alternative embodiments, only part of the battery pack housing may be rigid while achieving the same effect. For example, a base and optionally sidewalls of the battery pack may be rigid, with a less rigid lid, in which case the crash impact forces may be transmitted across the battery pack by the rigid base.

One drawback of using adhesive joints as well as or instead of mechanical fasteners is that an adhesive bond is generally permanent, whereas mechanical fasteners can be selectively engaged and disengaged to install and remove the battery pack from the vehicle body. It is therefore desirable to facilitate removal of the battery pack when adhesive joints are used. Preferably, bonding the battery pack to the frame using at least one adhesive joint comprises providing a conduit across at least one of said adhesive joints through which a wire may be inserted for cutting the at least one adhesive joint. The conduit may be a tube that is inserted between the battery pack and the frame prior to application of the adhesive forming the adhesive joint. The conduit may be left open at both ends or may be closed to prevent ingress of material. This conduit may nevertheless retain a hollow centre after formation of the adhesive joint and allow a convenient path along which a wire may be threaded for use in cutting the adhesive joint. As will be described in more detail below, once a wire has been arranged through the conduit, it may be pulled through the adhesive joint, e.g. by a technician holding onto ends of the wire one either side of the conduit, in order to cut the joint. To allow insertion of an appropriate wire for cutting the joint, preferably the conduit has a width of at least 0.5 mm, more preferably at least 1 mm, most preferably at least 2 mm.

To allow a wire to be appropriately arranged and operated at the time of removal of the battery pack, preferably the conduit is arranged such that a first end of the conduit is accessible from a first side of said adhesive joint and a second end of the conduit is accessible from a second side of said adhesive joint. For example, one end of the conduit should be inaccessibly located enclosed between the frame and the battery pack. Accessibility of both of ends of the conduit may be conveniently provided where the frame is provided with an opening therethrough at the floor portion. In such cases, one side of the conduit may be accessible from the exterior of the frame and the other side may be accessible through the opening through the frame at the floor portion. Other ways of providing access to both ends of the conduit are foreseen, including providing a conduit that extends across the full width of the battery pack, optionally across multiple adhesive joints.

In some embodiments, it may not be practical to provide a conduit across the adhesive joint(s) that is accessible from both sides so that a technician can insert and operate a wire for cutting the joint. Therefore, some embodiments further comprise providing the frame or the battery pack with at least one wire for cutting the at least one adhesive joint, wherein the cutting wire is arranged and secured in place such that a portion of the wire is accessible for pulling the wire through the at least one adhesive joint to cut the at least one adhesive joint. For example, at least one end of the wire may extend across an adhesive joint so as to be accessible by a technician for pulling through the adhesive joint. Some such embodiments comprise providing the frame or the battery pack with at least one wire for cutting the at least one adhesive joint wherein a first end of the wire is anchored to the frame or the battery pack, and wherein the battery pack is arranged and bonded to the frame such that a portion of the wire is accessible for pulling the wire through the at least one adhesive joint to cut the at least one adhesive joint.

There are a number of ways in which an integral wire may be arranged for use in cutting the adhesive joint. The wire may lie along a path, for example, substantially following a path of the at least one adhesive joint along the interface between the battery pack and the frame, optionally being weakly adhered or otherwise removably attached to the frame or battery pack along its length, with a portion of the wire, e.g. a second end in the case that a first end is anchored to the battery pack or frame, being located to be accessible to a technician. The technician may thus arrange the wire by the accessible end so that it extends across the adhesive joint, either through a conduit or at the end of an adhesive joint, and then pull the wire through the adhesive joint by the one accessible end. An anchored first end would ensure that the wire need only be pulled by a technician from one side of the adhesive joint (with the anchor point typically being located at the opposite side of the adhesive joint) in order to cut the joint.

Some embodiments comprise providing a conduit across at least one of said adhesive joints, wherein the first end of the wire is anchored to the frame or the battery pack at a first side of the conduit, and wherein the wire is arranged to pass through the conduit such that a portion of the wire is accessible from the second side of the conduit, or wherein the wire is arranged such that the portion of the wire is accessible through the conduit from the second side of the conduit. In these embodiments, a conduit across the adhesive joint is used for arranging or making accessible the integral cutting wire to facilitate cutting of the adhesive joint. The conduit in this case may be provided simply by arranging the cutting wire across the location of the adhesive joint before the adhesive is applied, so that the cutting wire is embedded across the adhesive and itself defines the conduit through the adhesive joint. Alternatively, a separate tube of the sort described above may be provided through which the wire extends across the adhesive joint.

As an alternative to anchoring one end of the wire to the battery pack or frame, the cutting wire may be provided so that opposing ends of the cutting wire pass through the same or respective conduits across at least one of said adhesive joints. A technician may therefore pull both ends of the wire to cut through the adhesive joint.

In the above embodiments including an integral cutting wire for cutting the adhesive joint, it will be appreciated that one or more integral cutting wires may be provided. One cutting wire may be used to cut multiple adhesive joints. Alternatively, separate joints may be provided with respective cutting wires. It would also be possible to provide multiple cutting wires that cut different sections of a single adhesive joint.

Preferably, the method further comprises electrically and/or hydraulically connecting the battery pack and the frame to one another. For example, the battery pack may be connected to the frame by an electrical conductor e.g. to provide a ground circuit. A ground circuit, for example, could be provided by the one or more mechanical fasteners. The mechanical fasteners should therefore be formed of an electrically conductive material.

In accordance with a second aspect of the invention, there is provide a method of removing a battery pack mounted to a vehicle body of a passenger vehicle, wherein the passenger vehicle comprises a vehicle frame defining at least a floor portion of a vehicle body and a battery pack in the floor portion of the vehicle body, the battery pack being bonded to the frame by at least one adhesive joint located at an interface between the battery pack and the frame, the method comprising pulling a wire along the at least one adhesive joint to cut the at least one adhesive joint.

This aspect of the invention corresponds to a method of removing a battery that has been mounted using a method according to the first aspect of the invention. Accordingly, the vehicle on which this method is performed may comprise any of the features described above with respect to the first aspect of the invention.

As indicated above, this method makes use of the technique described with respect to the first aspect of the invention for cutting the adhesive joints with a wire. This overcomes a key shortcoming of adhesive joints as compared with mechanical fasteners, which is the difficulty of removing the bonded battery pack. This method may be used to cut adhesive joints of any type described above with respect to the first aspect of the invention.

It should be noted that the pulling of the wire through the adhesive joint may be a manual action or could be assisted by tools or machinery.

In some embodiments, the passenger vehicle further comprises a conduit across at least one of said adhesive joints, and wherein the method comprises arranging the wire through the conduit and using the ends of the wire on either side of the conduit to pull the wire along the at least one adhesive joint to cut the at least one adhesive joint. This method may typically be performed where both sides of the conduit are accessible to the technician.

In other embodiments, the passenger vehicle comprises the wire, wherein a first end of the wire is anchored to the frame or the battery pack, and comprising retrieving a portion of the wire (typically the second end) and pulling the wire through the at least one adhesive joint by said portion to cut the at least one adhesive joint.

In any of the above embodiments, the method may further comprise heating the adhesive and/or the wire before pulling the wire through the at least one adhesive joint, wherein preferably heating the wire comprises passing an electric current through the wire. This may facilitate the cutting of the adhesive joint. In embodiments in which a first end of the wire is anchored to the frame or the battery pack, if the wire is to be heated using an electric current, preferably the anchor point connects the wire to a circuit for heating the wire. In use, a technician may retrieve the second end of the wire and complete the circuit in order to effect heating of the wire.

In accordance with a third aspect of the invention, there is provided a passenger vehicle comprising: a vehicle frame defining at least a floor portion of a vehicle body; and a battery pack in the floor portion of the vehicle body, the battery pack being bonded to the frame by at least one adhesive joint located at an interface between the battery pack and the frame.

The vehicle according to this aspect corresponds to a vehicle manufactured using the method according to the first aspect of the invention. Accordingly, the vehicle may comprise any of the features described above with respect to the first aspect of the invention.

Preferably, the one or more adhesive joints are located along a peripheral edge portion of the battery pack. More preferably, the one or more adhesive joints are located along at least two opposing peripheral edge portions of the battery pack. Most preferably, the one or more adhesive joints substantially surround a centre region of the battery pack.

In many embodiments, the battery pack comprises one or more peripheral flanges that forms at least part of the interface with the frame, wherein the one or more adhesive joints are located along one or more of said peripheral flanges.

Preferably, the interface between the battery pack and the frame includes one or more portions that define a substantially stepped interface, and wherein preferably the at least one adhesive joint is located on at least two different surfaces of one or more of said portions defining the substantially stepped interface.

In some embodiments, the floor portion of the vehicle generally defines a plane, and the interface between the battery pack and the frame includes one or more portions arranged at an angle to the plane defined by the floor portion, and the at least one adhesive joint is located at said one more portions of the interface that are arranged at an angle to the plane defined by the floor portion. Preferably, the interface between the battery pack and the frame includes portions arranged at different angles relative to the plane defined by the floor portion, and the at least one adhesive joint is located at said portions of the interface arranged at different angles relative to the plane defined by the floor portion. For the most advantageous handling of impact forces, preferably, the one or more portions of the interface between the battery pack and the frame are arranged at an angle that is generally inclined towards or away from a centre of the battery pack.

Preferably, the thickness of each adhesive joint is at least 0.5 mm, preferably at least 1 mm, more preferably at least 2 mm, most preferably at least 3 mm. Preferably, each adhesive joint is also elongate.

In some embodiments, the frame defines an opening therethrough at the floor portion, and wherein the battery pack closes said opening, thereby defining at least a region of the floor of the vehicle. In other embodiments, the frame defines a substantially continuous floor surface at the floor portion of the vehicle body, and wherein the battery pack is positioned substantially adjacent to said floor surface.

Many embodiments make use of both adhesive joints and mechanical fasteners. In such cases, the vehicle further comprises one or more mechanical fasteners located at an interface between the battery pack and the frame that, together with the adhesive joints, hold said battery pack in place on said frame.

Preferably, the frame comprises opposing longitudinal structural members located along opposing longitudinal edges of the floor portion of the vehicle body, and the battery pack is positioned in the floor portion of the vehicle body substantially between the opposing longitudinal structural members.

The vehicle may also be provided with any of the features described for enabling the adhesive joints to be conveniently cut. Preferably, the vehicle comprises a conduit across at least one of said adhesive joints through which a wire may be inserted for cutting the at least one adhesive joint. Preferably, the conduit is arranged such that a first end of the conduit is accessible from a first side of said adhesive joint and a second end of the conduit is accessible from a second side of said adhesive joint. In other embodiments, the frame or the battery pack comprises at least one wire for cutting the at least one adhesive joint, wherein a first end of the wire is anchored to the frame or the battery pack, and wherein the battery pack is mounted to the frame such that a portion of the wire is accessible for pulling the wire through the at least one adhesive joint to cut the at least one adhesive joint. The vehicle may further comprise a conduit across at least one of said adhesive joints, wherein the first end of the wire is anchored to the frame or the battery pack at a first side of the conduit, and wherein the wire passes through the conduit such that a portion of the wire is accessible from the second side of the conduit, or wherein the wire is positioned such that a portion of the wire is accessible through the conduit from the second side of the conduit. This wire may be arranged to substantially follow a path of the at least one adhesive joint along the interface between the battery pack and the frame.

### BRIEF DESCRIPTION OF DRAWINGS

The invention will now be described with reference to the accompanying drawings, of which:

FIG. 1 shows a top view of part of a vehicle body including a mounted battery pack;

FIG. 2 shows a schematic cross-section through the vehicle body and battery pack of FIG. 1;

FIG. 3 shows a schematic top view of the battery pack of FIG. 1 with the vehicle body omitted;

FIGS. 4A to 4E show five alternative schematic cross-sections through a vehicle body with a mounted battery pack;

FIG. 5 shows an enlarged detail of a schematic cross-section through a vehicle body with a mounted battery pack;

FIG. 6 shows a shematic top view of a mounted battery pack with the vehicle body omitted;

FIG. 7 shows a schematic top view of a mounted battery pack with the vehicle body omitted;

FIG. 8 is a flow diagram illustrating a method of mounting a battery pack in a vehicle body; and

FIG. 9 is a flow diagram illustrating a method of removing a battery pack mounted in a vehicle body.

### DETAILED DESCRIPTION

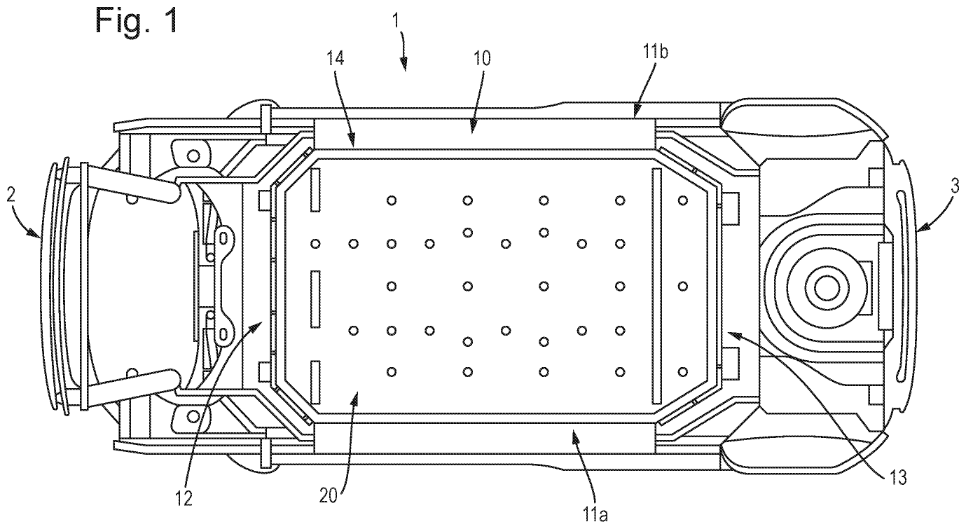

An embodiment will now be described in detail with reference to FIGS. 1 to 3. FIG. 1 shows part of a vehicle body 1. The vehicle body comprise a frame 10. This frame could be the so-called body in white (BIW). In FIG. 1, a floor frame section is shown, which comprises opposing longitudinal structural members 11a, 11b, which correspond to the rockers or door sill regions of the vehicle body. This floor frame could be part of the BIW, or could be a separate frame part that is to later be assembled into the BIW. The longitudinal structural members 11a, 11b extend along the longitudinal length of the cabin of the vehicle, between the front and rear wheels, and typically include crash absorbing structured designed to absorb side impact crashes. The frame 10 also includes a front transverse structural member 12 that extends between the longitudinal structural members 11a, 11b just behind the front wheel area of the body, and a rear transverse structural member 13 that extends between the longitudinal structural members 11a, 11b just ahead of the rear wheel area of the body. The transverse and longitudinal structural members thus delimit a floor portion of the vehicle body. The floor portion of the vehicle body generally defines a plane of the floor, which is substantially parallel to the ground. The transverse and longitudinal structural members also define a generally rectangular-shaped opening with truncated corners 14 through the floor portion in the vertical direction, in which the battery pack 20 is located. The front transverse structural member 12 is coupled to a front crash structure 2 and is designed to transmit front impact forces along the longitudinal structural members 11a, 11b and around the battery pack 20. Likewise, the rear transverse structural member 13 is coupled to a rear crash structure 3 and is designed to transmit rear impact forces along the longitudinal structural members 11a, 11b and around the battery pack 20.

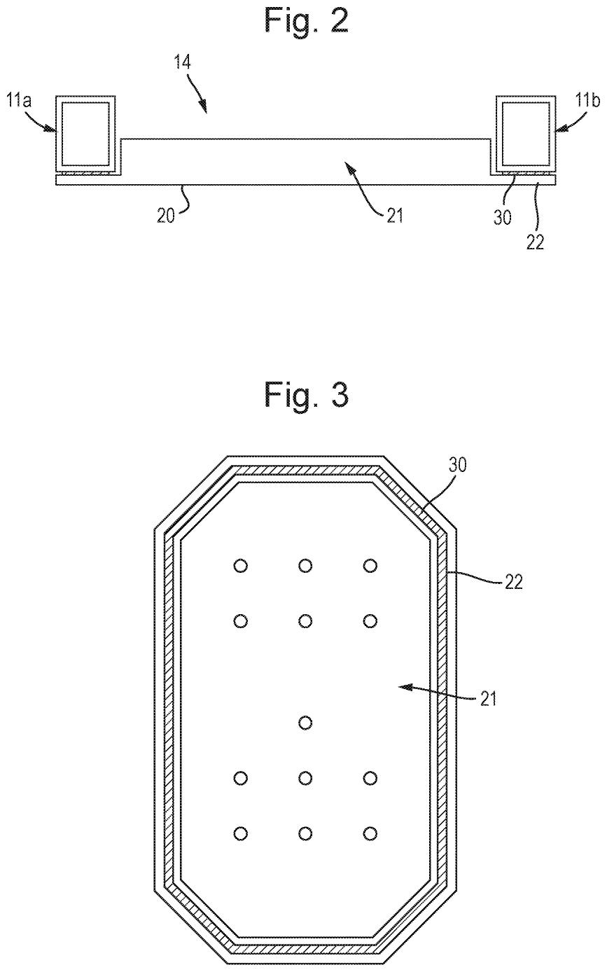

As mentioned above, the battery pack 20 is located in the opening 14 through the frame 10. The battery pack comprises a main housing 21 in which a plurality of battery modules is located, along with other battery components. The battery pack 20 generally corresponds in shape to the shape of the opening 14 through the frame 10. The battery pack is generally planar, having a width in the transverse direction that is similar in dimension to the width of the frame, and a length in the longitudinal direction that is similar in dimension to the length of the frame, but is relatively small in the vertical direction, being intended to sit substantially within the floor of the vehicle. At the peripheral edge of the battery pack 20, surrounding the main housing 21, is a peripheral flange 22. In this embodiment, the battery pack is to be inserted into the frame from beneath the frame, and so the flange 22 extends out from the lower face of the battery pack away from a central axis of the battery pack that is perpendicular to the general plane of the battery pack. The flange has a smaller thickness in the vertical direction than the main housing 21 of the battery pack. Therefore, when inserted from below the frame 10, the peripheral flange 22 may engage the transverse and longitudinal structural members, 11a, 11b, 12, 13, along respective sides of the battery pack 20, while much of the main housing 21 sits inside the opening 14, substantially between the transverse and longitudinal structural members, 11a, 11b, 12, 13. FIG. 2 shows a cross-section through the frame in a plane extending along the vertical and transverse directions, and shows the main housing of the battery being located between the longitudinal structural members, 11a, 11b, with the upper face of the flange 22 and the vertical side walls of the housing 21 forming an interface with the frame 10.

The battery pack 20 in this embodiment is mounted within the frame 10 using an adhesive joint 30, which is shown in FIGS. 2 and 3. As can be seen in FIG. 2, the adhesive joint is positioned on the upper surface of the peripheral flange 22 of the battery pack and bonds the peripheral flange to lower faces of the lateral structural members 11a, 11b. The lower faces of the transverse and longitudinal structural members 11a, 11b, 12, 13 define as a complementary rim about the opening 14 that engages with the peripheral flange. While this interface between the upper surface of the flange 22 and the lower surface of the transverse and longitudinal structural members 11a, 11b, 12, 13 is shown as flat surfaces, it will be appreciated that any complementary interfaces may be used.

FIG. 3 shows a top view of the battery pack 20, with the frame 10 omitted, so that the path followed by the adhesive joint 30 can be seen. As shown in FIG. 3, the main housing of the battery pack has a footprint that is generally rectangular, with truncated corners, to match the shape of the opening 14 through the frame. Around the entire periphery of this main housing 21, the peripheral flange 22 extends from the lower surface of the battery pack, so that there is a step down from the upper surface of the battery pack to the upper surface of the peripheral flange 22. The adhesive joint 30 is provided in one continuous path that extends around the entire peripheral flange 22 of the battery pack 20 so as to surround the main housing 21. This enables the battery pack to be bonded to the frame 10 about the entire periphery of the battery pack.

The adhesive used for the adhesive joint 30 may be a ductile structural adhesive with polyurethane chemistry. The material of the battery case housing 21 and the flange 22 may be a composite material comprising a resin matrix, reinforcement fibres and metallic inserts. For example, the material of the battery case housing 21 may be carbon fibre reinforced polypropylene, which may have a Young's modulus of >20 GPa. In alternative embodiments, the housing may be formed of aluminium, which may have a Young's modulus of approximately 70 GPa. The frame 10 may be made of an assembly of aluminium alloys. While these materials are typical, in principle, any combinations of materials for the battery pack and frame may be used with an adhesive suitable for bonding those materials.

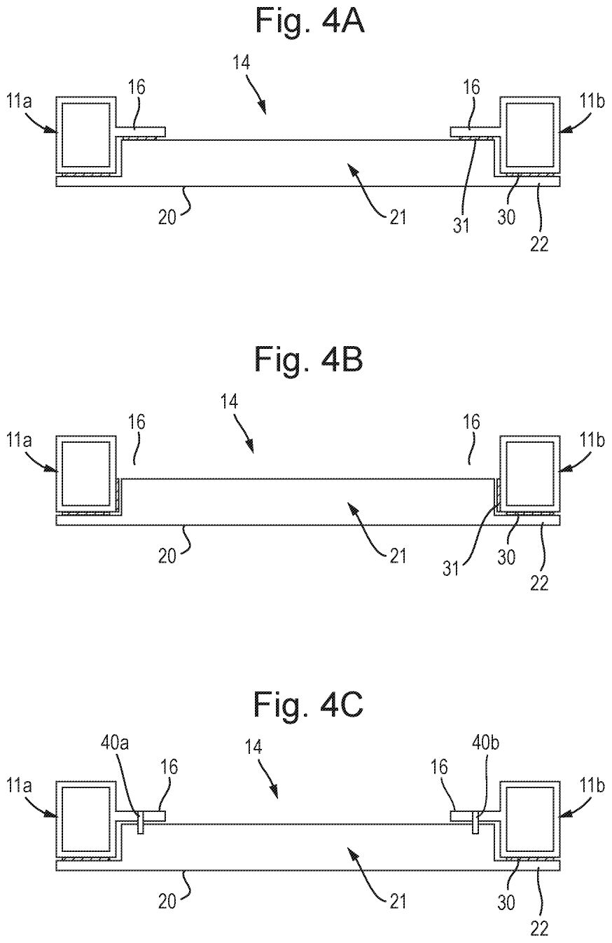

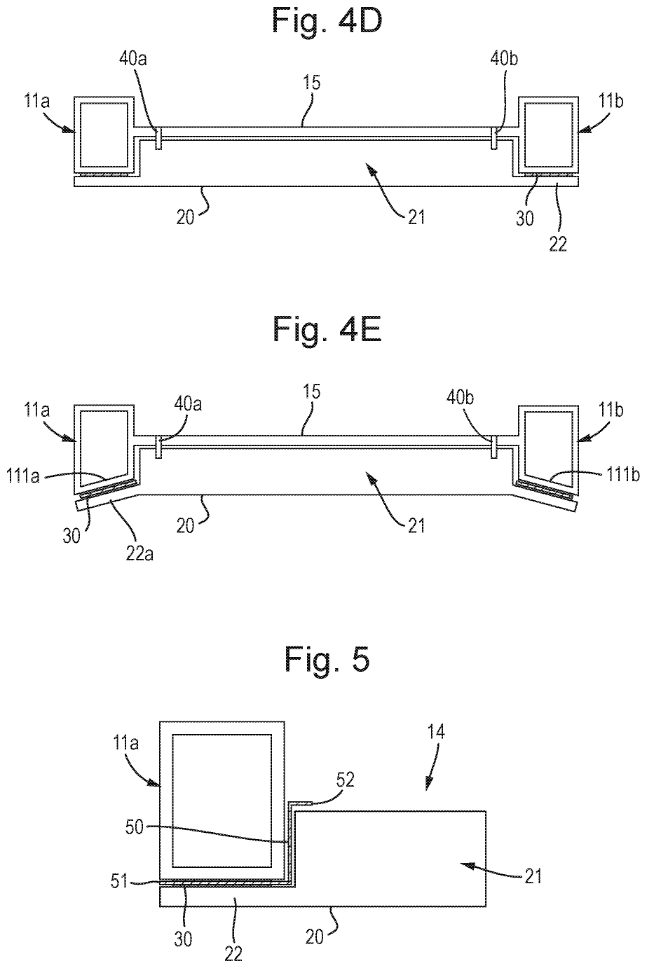

FIGS. 1 to 3 illustrate one possible interface and mounting arrangement for the battery pack 20 and frame 10, but various other mounting arrangements are possible. Some alternative configurations will now be described with reference to FIGS. 4A to 4E, each of which is an alternative cross-section through the frame 10 in a plane extending along the vertical and transverse directions. The differences between these alternative embodiments and that of FIGS. 1 to 3 will now be described.

FIG. 4A shows an embodiment in which the frame 10 is further provided with a flange 16 that projects from the side walls of the transverse and longitudinal structural members 11a, 11b, 12, 13 partially into the opening 14 for engaging an upper surface of the main housing 21 of the battery pack 20. This defines a substantially stepped interface between the battery pack 20 and the frame 10. The battery pack is additionally bonded to the frame 20 by a second adhesive joint 31 that is positioned between the lower surface of the flange 16 of the frame 10 and the upper surface of the main housing 21 of the battery pack. This second adhesive joint may be provided to extend around the entire periphery of the upper surface of the main housing 21 or may only extend partially around the periphery. This second adhesive joint increases the strength of the bond between the battery pack 20 and the frame 10.

FIG. 4B shows an embodiment in which the interface between the frame 10 and the battery pack 20 is the same as that of FIGS. 1 to 3. However, in this embodiment, a second adhesive joint 31 is provided between the vertical side wall of the main housing 21 of the battery pack 20 and the inner side walls of the transverse and longitudinal structural members 11a, 11b, 12, 13, which face into the opening 14. Not only does this second adhesive joint increase the strength of the bond between the battery pack 20 and the frame 10, but arranging two adhesive joints on surfaces that define an angle to one another ensures that the adhesive joints will experience the same force in different relative directions. For example, a side impact force may produce a shear force on the first adhesive joint 30, but a compressive force on the second adhesive joint 31. This decreases the risk that both adhesive joints would fail as a result of the same impact.

FIG. 4C shows an embodiment in which the interface between the battery pack 20 and the frame 10 is the same as that described with reference to FIG. 4A, with a flange 16 that projects from the side walls of the transverse and longitudinal structural members 11a, 11b, 12, 13 partially into the opening 14. However, in this embodiment, there is no adhesive joint provided along the interface between the flange 16 and the upper face of the main housing 21 of the battery pack. Instead, the interface between the flange 16 and the upper face of the main housing 21 is provided with a number of mechanical fasteners 40a, 40b. Only two mechanical fasteners are shown in the cross-section of FIG. 4C, but it will be appreciated that mechanical fasteners may be provided in a number of places around the interface between the battery pack 20 and the frame 10. In this embodiment, the mechanical fasteners comprise bolts. Threaded bolt shafts are provided that project out of the upper face of the main housing 21 of the battery pack. These bolt shafts are received in corresponding holes through the flange 16 and are secured with nuts so that the battery pack is bolted to the frame. While bolts are described as the mechanical fasteners in this embodiment, it will be appreciated that any type of mechanical fastener may be used, including clips, pins or rivets, among others. In this embodiment, the use of mechanical fasteners 40a, 40b in addition to the adhesive joint 30 between the flange 22 of the battery pack 20 and the frame ensures that the battery mount is more resilient to the different failure modes affecting each joint type individually. Mechanical fasteners may also be useful for seating the battery pack and holding the battery pack in place while the adhesive dries.

FIG. 4D shows an embodiment in which a substantially continuous floor surface 15 extends between the transverse and longitudinal structural members 11a, 11b, 12, 13 so that there is no opening through the frame in the vertical direction. In this embodiment, the battery pack is mounted to the frame by an adhesive joint 30 that is again provided in one continuous path that extends around the entire peripheral flange 22 of the battery pack 20 so as to surround the main housing 21. Additionally, mechanical fasteners 40a, 40b are again provided in the form of bolts, with the threaded bolt shafts being provided to project out of the upper face of the main housing 21 of the battery pack, but in this embodiment being received in corresponding holes through the substantially continuous floor surface 15.

FIG. 4E shows an embodiment that differs from that of FIG. 4D in that the interface between the battery pack and the frame along which the adhesive joint is provided includes portions arranged at an oblique angle relative to the horizontal plane. In particular, instead of the peripheral flange 22 extending in the horizontal plane, in this embodiment, a flange 22a is provided at an angle that slopes down in the direction away from the main housing 21 of the battery pack. As shown in FIG. 4E, this means that the angle that the flange makes to the horizontal (i.e. the plane of the floor and the battery pack) on the left side of FIG. 4E is one rotated anticlockwise by about 10°, and on the right side of FIG. 4E is one rotated clockwise by about 10°. While not shown in this Figure, the flange along the front and rear edges of the battery pack 20 is similarly sloped down and way from the main housing 21 of the battery pack. The lower face of the transverse and longitudinal structural members 11a, 11b, 12, 13 is inclined in a complementary manner, i.e. sloping downward in the direction away from the centre of the frame. The adhesive joint 30 is provided between the inclined upper surface of the flange 22a and the inclined lower surface of the transverse and longitudinal structural members 11a, 11b, 12, 13. This interface shape means that a side impact force will place the adhesive joint partly in compression instead of in pure shear, meaning it is less likely to fail.

It will be appreciated that the various features described above with respect to the alternative cross-sections could be combined as desired. For example, the inclined flange 22a of FIG. 4E could be provided in any of the embodiments of FIG. 2 or 4A to 4D. Similarly, the second adhesive joint 31 on the vertical sidewalls in FIG. 4B could be provided in any of the other embodiments.

FIG. 5 shows an enlarged portion of a frame and battery pack constructed in substantially the same way as described with reference to FIGS. 1 to 3. However, in this embodiment, a conduit 50 has been provided across the adhesive joint 30. This conduit may be a passage through the adhesive joint created by including the wire inside the adhesive before this is rigidified. Alternatively, this conduit may be a small tube made of soft and thin rubbery or polymeric material, for example EPDM or ABS, approximately 2 mm in diameter, that extends across the adhesive joint 30. In this embodiment, the conduit follows a path starting at a first end 51, which is located at the very outer edge of the peripheral flange in the opening into the gap between the flange and the lower face of the longitudinal structural member, so as to be accessible from the outside of the frame. The conduit extends from this first end 51 across adhesive joint, towards the centre of the battery pack. The conduit follows the interface between the frame 10 and the battery pack 20 until it reaches the opening through the frame. The second end 52 of the conduit is thus accessible near the upper surface of the main housing 21 of the battery pack 20 through the opening 14 through the frame 10. As will be described in more detail below, this conduit may be used in removing the battery pack from the frame. In particular, a technician may insert a cutting wire through the first or second end 51, 52, along the conduit 50 and retrieve the wire at the opposite end. With the wire so arranged, the technician may pull the wire through the adhesive joint, following the path of the adhesive joint around the battery pack 20, to cut the adhesive joint to allow for removal of the battery pack.

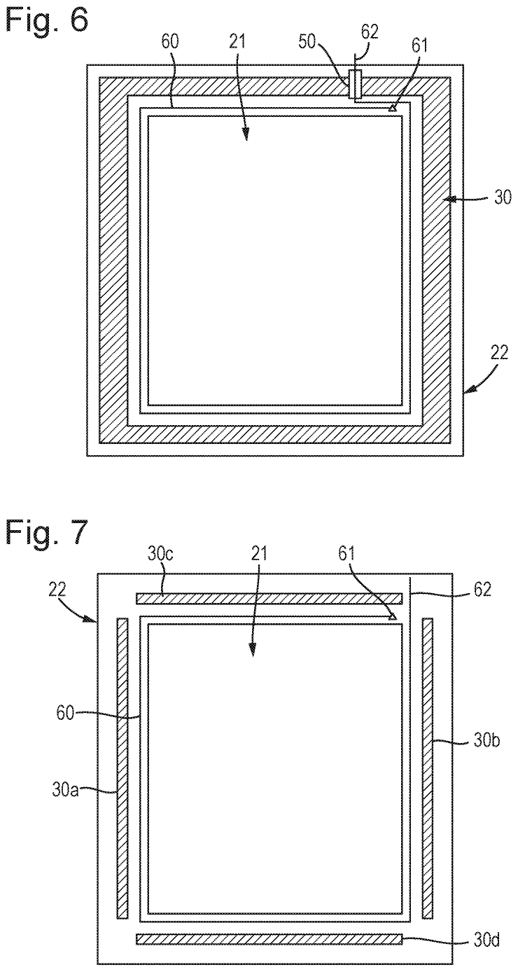

An alternative embodiment allowing for removal of the battery pack 20 is shown in FIG. 6, which shows a top view of a battery pack. This battery pack is substantially square in profile, and again comprises a main housing 21 that holds the battery modules and the like, and a peripheral flange 22 extending therefrom. Once again, an adhesive joint 30 is provided that extends along this peripheral flange 22, surrounding the main housing 21 of the battery pack 20. In this embodiment, an integral cutting wire 60 is provided on the battery pack. This wire may be made of stainless steel and may be 1 mm in diameter, for example. The wire could have a circular cross-section or a square or rectangular cross-section to define sharper cutting edges. Alternatively, the wire could be a braided cutting wire. Most of the length of the wire extends along the peripheral flange 22, positioned between the main housing 21 and the adhesive joint 30. The wire may be weakly adhered to the flange 22 by small dots of adhesive. A first end 61 of the cutting wire 60 is fixedly anchored to the battery pack. In this embodiment, the first end is anchored next to the top left corner of the main housing 21, as shown in FIG. 6. The cutting wire follows a path, anticlockwise in FIG. 6, extending completely around the main housing 21. A short section of the wire overlaps itself after having completed one full path around the main housing 21 and then the second end of the wire passes through a conduit 50 that is provided across the adhesive joint 30. The free second end is thus provided at the outer edge of the battery pack 20, where it may be accessed by a technician. In order to cut the adhesive, a technician need only retrieve the second end of the wire 62 and pull the wire through the adhesive joint, following the path of the adhesive joint around the battery pack 20.

An alternative embodiment is shown in FIG. 7. This embodiment differs from FIG. 6 in that four separate adhesive joints are provided along respective edges of the battery pack corresponding respectively to the edges of the transverse and longitudinal structural members 11a, 11b, 12, 13. In this embodiment, the second end of the wire 62 may simply be provided through the gap between two adjacent adhesive joints, to allow second end of the wire to be accessible along the outer edge of the battery pack 20.

It will be appreciated that a cutting wire of the sort described with respect to FIGS. 6 and 7 may be provided in any of the embodiments described above with respect to FIGS. 1 to 4E.

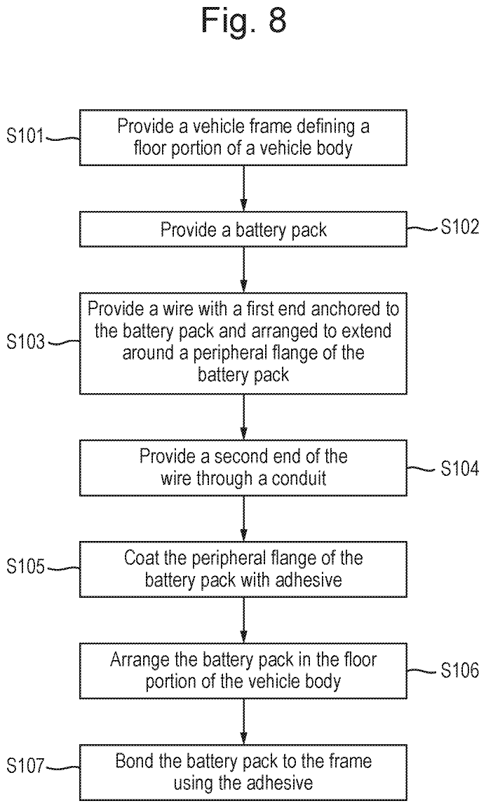

The process for mounting a battery pack in the frame of the vehicle body will now be described with further reference to FIG. 8. In a first step S101, the vehicle frame is provided, which defines the floor portion of the vehicle body, and in step S102, the battery pack to be mounted to the frame is provided. The frame 10 may be any of the frames described above with respect to FIGS. 1 to 4E in particular and the battery pack 20 may be the corresponding battery pack described above.

In step S103, a cutting wire 60 is provided. The cutting wire has its first end 61 anchored to the battery pack 20 at a point that will be located with the adhesive joints that are applied in subsequent steps. Any suitable anchoring member may be used for this purpose, such as an eye bolt to which the wire is tied. The wire is provided so as to extend around the periphery of the battery pack, following a path that will be slightly inside the path of the adhesive joints that are applied in subsequent steps until the wire has extended substantially around the full perimeter of the battery pack 20. As mentioned above, to hold the wire in place on battery pack 20, small dots of adhesive may be applied at regular intervals along the path of the wire.

In step S104 a conduit 50 is provided and arranged near the second end 62 of the wire and arranged so that it will extend across the adhesive joints that are applied in subsequent steps. The second end of the wire 62 is then passed through the conduit 50. It will be appreciated that steps S103 and S104 may be omitted if no integral cutting wire is to be provided with the battery pack, or a conduit may be arranged so that it will extend across the adhesive joint without any wire, if a separate cutting wire is intended to remove the battery pack.

In step S105, an adhesive is applied to coat the peripheral flange 22 of the battery pack 20. As described above, this adhesive is preferably a paste-like, ductile structural adhesive with polyurethane chemistry and is applied by coating the peripheral flange 22 of the battery pack 20 while the peripheral flange is horizontal and facing upwards. The adhesive is applied with a thickness of at least 3 mm, which will compensate for any roughness in the surface of either the battery pack or the frame. The adhesive is applied to define the one or more adhesive joints 30, typically extending around the entire periphery of the battery pack to surround the main housing 21 of the battery pack. The adhesive is applied so that it extends over the conduit provided in step S104, such that the second end of the wire may nonetheless be accessed and move freely in the conduit 50.

In step S106, the battery pack 20 is arranged in position in the floor portion defined by the frame 10. The battery pack is arranged so that the adhesive on the battery pack is located at the appropriate interface with the frame 10, as described above. In this step, any mechanical fasteners 40a, 40b may be used to correctly position the battery pack 20 in place and so could include means to guide and locate the battery pack into its exact location within the vehicle frame during the arranging step. For example, if the mechanical fasteners include bolts, then the bolt shaft and complementary bolt holes may assist in positioning the frame and battery pack. A similar effect can be achieved without mechanical fasteners using dowel pins or the like.

Finally, in step S107, the battery pack is bonded to the frame using the adhesive joints. This process may involve pressing the battery pack against the frame while the adhesive sets. This may simply involve lowering the frame onto the battery pack or else by pressing the battery pack up into the frame so that the weight of the frame works to press the battery pack against the frame and counteract the hydraulic force generated by the adhesive squeeze out. However, preferably mechanical fasteners 40a, 40b are used, which may be used to clamp the battery pack against the frame, while the adhesive sets to bond the battery pack to the frame. These mechanical fasteners between the battery pack and the vehicle frame may clamp the two together during the bonding in order to counteract the hydraulic force generated by the adhesive squeeze out. Such mechanical fasteners could be driven to hard stop through compression limiters so as to control the adhesive gap to an exact dimension and avoid hard contact between the vehicle frame and the battery case. For example, where the mechanical fasteners include bolts, a 3 mm spacing element may be placed on one or more of the bolt shafts between the battery pack and the frame to ensure an adhesive joint thickness of 3 mm. The mechanical fasteners could also exclusively provide the means to hold the battery pack in place whilst the adhesive rigidifies, thus enabling subsequent vehicle handling operations whilst the adhesive achieves its full strength.

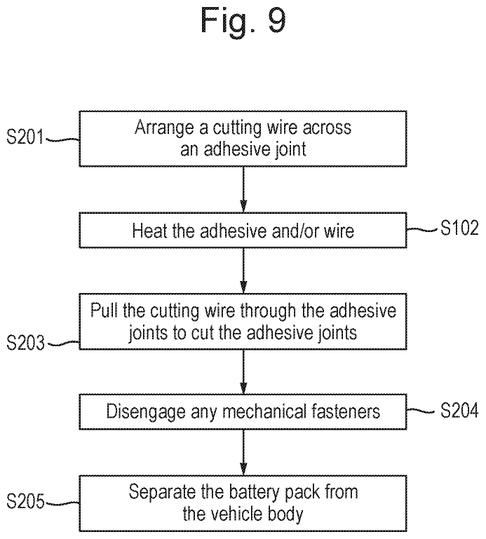

The process of removing a battery pack mounted in the above manner will now be described with further reference to FIG. 9. In a first step, S201, a cutting wire is arranged across an adhesive joint. In the case of an embodiment of the likes shown in FIG. 5, this may involve threading a cutting wire along a conduit 50 provided across an adhesive joint from a first end 51 to a second end 52, where the wire is retrieved. In the case of an embodiment of the sort shown and described in relation to FIGS. 6 and 7, the cutting wire may be provided prearranged across the adhesive joint.

In step S202, the adhesive and/or the wire may be heated. Heating of the adhesive may soften the adhesive, while heating the wire cause the wire to soften the adhesive as it comes into contact with the adhesive. The adhesive may be heated by placing a heat source in contact with the opposing surface of the peripheral flange. The wire may be heated by a resistive process. If the wire is anchored at one end to the battery pack or frame, the anchor point could include an electrical connection to the vehicle ground or to a dedicated circuit of the vehicle that is accessible in the vehicle when the battery is being serviced.

In step S203, the wire is pulled through the adhesive joints. The cutting wire may be pulled so as to follow the adhesive joints along their path about the battery pack. The pulling may be done manually or assisted by tools. If an integral cutting wire is used, only one end of the wire will need to be pulled with the other remaining anchored in place. If a separate cutting wire is used, both ends may need to be operated to pull the wire through the adhesive joints. Once the wire has been pulled through the full path of the adhesive joints, the adhesive will be cut.

In step S204, any mechanical fasteners 40a, 40b may be disengaged. For example, if the battery pack 20 is also bolted to the frame, then the bolts may be removed to allow the battery pack to be extracted.

Finally, in step S205, the battery pack, with the adhesive joints cut and any mechanical fasteners disengaged, is separated from the frame of the vehicle body.

1. A method of mounting a battery pack to a vehicle body of a passenger vehicle, the method comprising:
providing a vehicle frame defining at least a floor portion of a vehicle body;
providing a battery pack;
arranging the battery pack in the floor portion of the vehicle body; and
bonding the battery pack to the frame using at least one adhesive joint located at an interface between the battery pack and the frame.

2. (canceled)

3. (canceled)

4. (canceled)

5. (canceled)

6. (canceled)

7. (canceled)

8. (canceled)

9. (canceled)

10. (canceled)

11. (canceled)

12. (canceled)

13. (canceled)

14. (canceled)

15. (canceled)

16. (canceled)

17. (canceled)

18. (canceled)

19. (canceled)

20. (canceled)

21. (canceled)

22. (canceled)

23. (canceled)

24. (canceled)

25. (canceled)

26. (canceled)

27. (canceled)

28. (canceled)

29. A vehicle body for a passenger vehicle, the vehicle body comprising:
a vehicle frame defining at least a floor portion of the vehicle body; and
a battery pack in the floor portion of the vehicle body, the battery pack being bonded to the frame by one or more adhesive joints located at an interface between the battery pack and the frame.

30. A vehicle body according to claim 29, wherein the one or more adhesive joints are located along a peripheral edge portion of the battery pack.

31. A vehicle body according to claim 30, wherein the one or more adhesive joints are located along at least two opposing peripheral edge portions of the battery pack.

32. (canceled)

33. A vehicle body according to claim 29, wherein the battery pack comprises one or more peripheral flanges configured to form at least part of the interface with the frame, wherein the one or more adhesive joints are located along one or more of said peripheral flanges.

34. A vehicle body according to claim 29, wherein the floor portion of the vehicle generally defines a plane, wherein the interface between the battery pack and the frame includes one or more portions arranged at an angle to the plane defined by the floor portion, and wherein the at least one adhesive joint is located at said one more portions of the interface that are arranged at an angle to the plane defined by the floor portion.

35. A vehicle body according to claim 34, wherein the interface between the battery pack and the frame includes portions arranged at different angles relative to the plane defined by the floor portion, and wherein the at least one adhesive joint is located at said portions of the interface arranged at different angles relative to the plane defined by the floor portion.

36. A vehicle body according to claim 34, wherein the one or more portions of the interface between the battery pack and the frame are arranged at an angle that is generally inclined towards or away from a centre of the battery pack.

37. A vehicle body according to claim 29, wherein a thickness of each adhesive joint is at least 0.5 mm.

38. (canceled)

39. (canceled)

40. (canceled)

41. A vehicle body according to claim 29, wherein the battery pack is further joined to the frame by one or more mechanical fasteners.

42. A vehicle body according to claim 41, wherein the one or more mechanical fasteners include one or more spacing elements configured prevent direct contact between the battery pack and the frame.

43. A vehicle body according to any of claim 29, wherein the frame comprises opposing structural members, wherein the battery pack is arranged between the opposing structural members and wherein the battery pack is joined to each of the opposing structural members.

44. A vehicle body according to claim 43, wherein the floor portion of the vehicle generally defines a plane, wherein the interface between the battery pack and the frame includes one or more portions arranged at an angle to the plane defined by the floor portion, and wherein the at least one adhesive joint is located at said one more portions of the interface that are arranged at an angle to the plane defined by the floor portion, and wherein the opposing structural members define the one or more portions arranged at an angle to the plane defined by the floor portion.

45. A vehicle body according to claim 29, wherein the frame defines at least part of a floor surface at the floor portion of the vehicle body and a structural member extending away from the floor surface, and wherein the battery pack is joined to the structural member and the battery pack is joined to the floor surface of the frame interface

46. A vehicle body according to claim 29, wherein the frame comprises opposing longitudinal structural members located along opposing longitudinal edges of the floor portion of the vehicle body, wherein the battery pack is arranged substantially between the opposing longitudinal structural members.

47. A vehicle body according to of claim 29, wherein a material of the battery pack at the location of the adhesive joint has a Young's modulus of at least 1 GPa.

48. A vehicle body according to claim 29, wherein the battery pack comprises a housing, wherein a material of the housing extending between the adhesive joint and either another joint between the battery pack and the frame or another section of the same adhesive joint has a Young's modulus of at least 1 GPa.

49. A vehicle body according to claim 48, wherein the frame comprises opposing structural members, wherein the battery pack is arranged between the opposing structural members and wherein the battery pack is joined to each of the opposing structural members, and wherein the material of the housing extending between the opposing structural members has a Young's modulus of at least 1 GPa.

50. A vehicle body according to claim 29, wherein a conduit is provided across at least one of said adhesive joints through which a wire may be inserted for cutting the at least one adhesive joint.

51. (canceled)

52. (canceled)

53. (canceled)

54. (canceled)

55. A method of removing a battery pack mounted to a vehicle body of a passenger vehicle, wherein the passenger vehicle comprises a vehicle frame defining at least a floor portion of a vehicle body and a battery pack in the floor portion of the vehicle body, the battery pack being bonded to the frame by at least one adhesive joint located at an interface between the battery pack and the frame, the method comprising pulling a wire through the at least one adhesive joint to cut the at least one adhesive joint.

56. (canceled)

57. (canceled)

58. (canceled)

59. (canceled)
